(19) United States
(12) Patent Application Publication
(10) Pub. No.: US 2018/0223570 A1
(43) Pub. Date: Aug. 9, 2018

(54) THEFT PREVENTION SADDLEBAG RECEIVER LATCH BRACKET

(71) Applicant: Robert Warren Becker, Sacramento, CA (US)

(72) Inventor: Robert Warren Becker, Sacramento, CA (US)

(21) Appl. No.: 15/800,477

(22) Filed: Nov. 1, 2017

Related U.S. Application Data
(60) Provisional application No. 62/454,398, filed on Feb. 3, 2017.

(51) Int. Cl. E05B 85/04; E05B 15/02; E05B 65/52; B62J 9/00

(52) U.S. Cl. CPC E05B 85/04; B62J 9/00; E05B 65/52; E05B 15/0205

(57) ABSTRACT

A theft prevention saddlebag receiver latch bracket may include a base and a guide ramp. A first sidewall and a second sidewall may couple the base and guide ramp together to form a lid latch hook cavity. The guide ramp may include a latch ramp surface and a retaining surface. The base may further include a latch stop and one or more mounting apertures. A lid latch hook may be guided by the guide ramp and sidewalls into the lid latch hook cavity. The retaining surface may engage with the lid latch hook to retain the lid latch hook in the lid latch hook cavity to limit vertical movement of the lid latch hook. Outward movement of the lid latch hook, away from the base, may be limited by the latch ramp surface, while inward movement of the lid latch hook, towards the base, may be limited by the latch stop.

### CROSS REFERENCE TO RELATED APPLICATIONS

This application claims priority to and the benefit of the filing date of U.S. Provisional Application No. 62/454,398, filed on Feb. 3, 2017, entitled “THEFT PREVENTION SADDLEBAG RECEIVER LATCH BRACKET”, which is hereby incorporated by reference in its entirety.

### FIELD OF THE INVENTION

This patent specification relates to the field of saddlebag locking devices. More specifically, this patent specification relates to a bracket device which is able to mate with currently available lid latch hooks while preventing currently available lid latch hooks from being pried or forcibly removed from the bracket device.

### BACKGROUND

The lid (top) of a Harley Davidson FL Touring style hard saddlebag is held in place with a receiver latch bracket (two per saddlebag) attached to the back side of the lower portion of the saddlebag. The latch bracket is made from stamped metal and has a flexible guide ramp that captures the lid latch hook, (part of the saddlebag lid) to hold the lid in place when the saddlebag is closed, latched and locked.

This bracket(s) offer no incursion protection thus making it easy to open a locked saddlebag by prying the lid latch hook out of the receiver latch bracket making it possible to remove the saddlebag contents and or the saddlebag from the motorcycle. Incursion into the saddlebag is achieved when the lid latch hook(s) is pried forward from the rear of the receiver latch bracket, (using common items such as a flat bladed screwdriver, putty knife or other similar items) allowing the lid latch hook to be pulled up releasing it from the receiver latch bracket.

Therefore, a need exists for a novel receiver latch bracket device that prevents a lid latch hook from being pried or forced out of the receiver latch bracket when the saddlebag lid has been closed, latched and locked.

### BRIEF SUMMARY OF THE INVENTION

A theft prevention saddlebag receiver latch bracket is provided. The bracket may be coupled to saddlebags typically used on motorcycles and be used to receive a lid latch hook commonly employed on the saddlebags to secure the lid and body of the saddlebags together. Once a lid latch hook is received by the bracket, the lid latch hook and bracket are prevented from being pried apart.

In some embodiments, a theft prevention saddlebag receiver latch bracket may include a base and a guide ramp. A first sidewall and a second sidewall, opposingly positioned to each other, may couple the base and guide ramp together so that the guide ramp and base are opposingly positioned to each other. A lid latch hook cavity may be formed between the base, latch stop, first sidewall, second sidewall, and guide ramp. The guide ramp may further comprise a latch guide surface, a latch ramp surface, and a retaining surface. The base may further include a latch stop. A lid latch hook may be guided by the guide ramp and sidewall and into the lid latch hook cavity. The retaining surface may engage with the lid latch hook to retain the lid latch hook in the lid latch hook cavity to limit vertical movement of the lid latch hook. Outward movement of the lid latch hook, away from the base, may be limited by the latch ramp surface, while inward movement of the lid latch hook, towards the base, may be limited by the latch stop. In this manner, once a lid latch hook is received by the bracket, the lid latch hook and bracket are prevented from being pried apart by the close proximity between the lid latch hook and the latch stop, guide ramp, and sidewalls.

In further embodiments, the bracket may have a generally trapezoidal prism shaped a lid latch hook cavity formed between the base, latch stop, first sidewall, second sidewall, and guide ramp by having the first sidewall and second sidewall angled relative to each other.

In still further embodiments, the latch stop may include a latch stop horizontal surface, and the latch stop horizontal surface may be positioned approximately between 0.5 and 0.20 inches below the retaining surface.

In yet further embodiments, the latch stop may include a latch stop vertical surface, and the latch stop vertical surface may be positioned approximately between 0.50 and 0.25 inches away from the latch ramp surface.

### BRIEF DESCRIPTION OF THE DRAWINGS

Some embodiments of the present invention are illustrated as an example and are not limited by the figures of the accompanying drawings, in which like references may indicate similar elements and in which:

FIG. 1—FIG. 1 depicts a top rear perspective view of an example of a theft prevention saddlebag receiver latch bracket according to various embodiments described herein.

FIG. 2—FIG. 2 illustrates another top rear perspective view of an example of a theft prevention saddlebag receiver latch bracket according to various embodiments described herein.

FIG. 3—FIG. 3 shows a front elevation view of an example of a theft prevention saddlebag receiver latch bracket according to various embodiments described herein.

FIG. 4—FIG. 4 depicts a rear elevation view of an example of a theft prevention saddlebag receiver latch bracket according to various embodiments described herein.

FIG. 5—FIG. 5 illustrates a sectional, through line 5-5 shown in FIG. 4, elevation view of an example of a theft prevention saddlebag receiver latch bracket according to various embodiments described herein.

FIG. 6—FIG. 6 shows a sectional, through line 6-6 shown in FIG. 4, elevation view of an example of a theft prevention saddlebag receiver latch bracket according to various embodiments described herein.

FIG. 7—FIG. 7 depicts a front bottom perspective view of an example of a theft prevention saddlebag receiver latch bracket according to various embodiments described herein.

FIG. 8—FIG. 8 illustrates a top rear perspective view of an example of a theft prevention saddlebag receiver latch bracket according to various embodiments described herein.

FIG. 9—FIG. 9 shows a perspective view of an example of a lid latch hook which may be used with a theft prevention saddlebag receiver latch bracket according to various embodiments described herein.

FIG. 10—FIG. 10 depicts a sectional elevation view of a lid latch hook received by an example of a theft prevention saddlebag receiver latch bracket according to various embodiments described herein.

FIG. 11—FIG. 11 illustrates a top rear perspective view of an alternative example of a theft prevention saddlebag receiver latch bracket according to various embodiments described herein.

FIG. 12—FIG. 12 shows a top rear perspective view of another alternative example of a theft prevention saddlebag receiver latch bracket according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

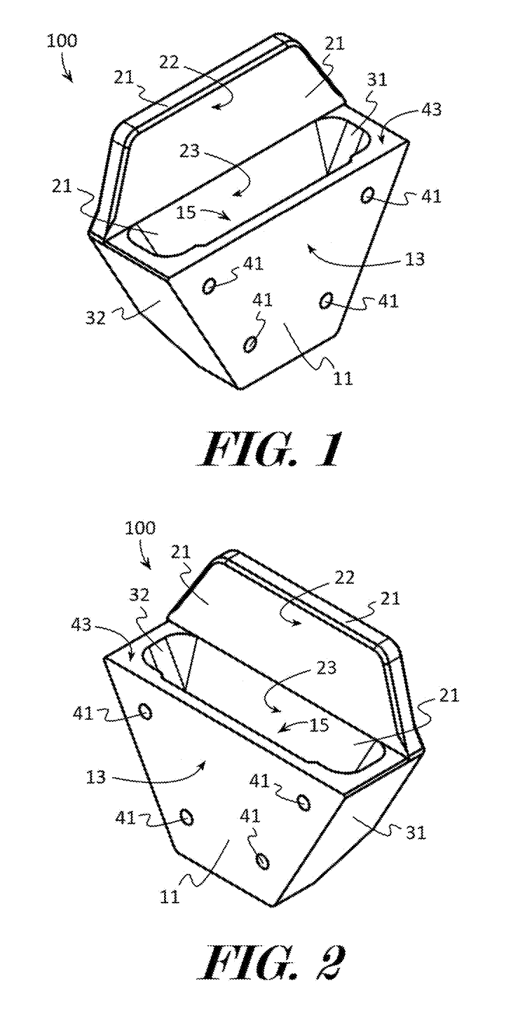

For purposes of description herein, the terms “upper”, “lower”, “left”, “right”, “rear”, “front”, “side”, “vertical”, “horizontal”, and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Although the terms “first”, “second”, etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 10% of the specified number. Additionally, as used in this application, the term “substantially” means that the actual value is within about 10% of the actual desired value, particularly within about 5% of the actual desired value and especially within about 1% of the actual desired value of any variable, element or limit set forth herein.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

A new saddlebag locking device is discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

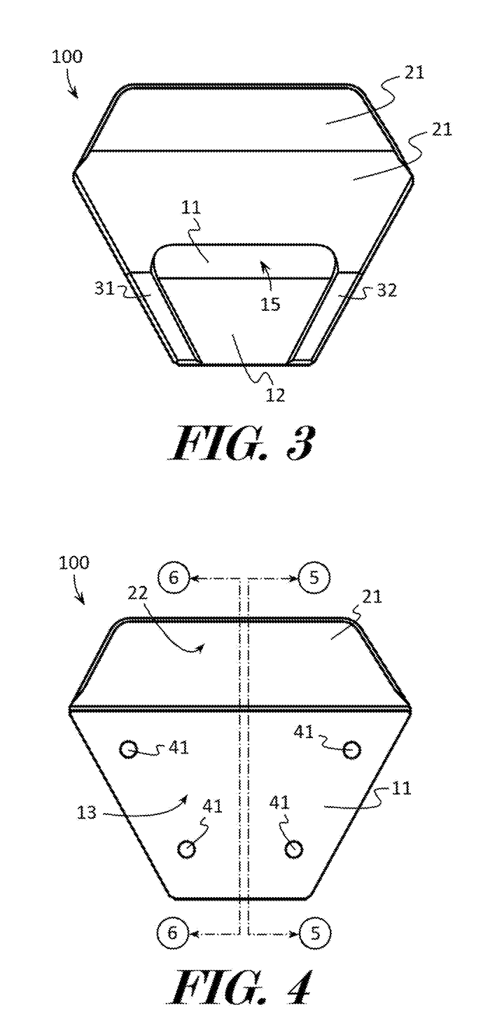

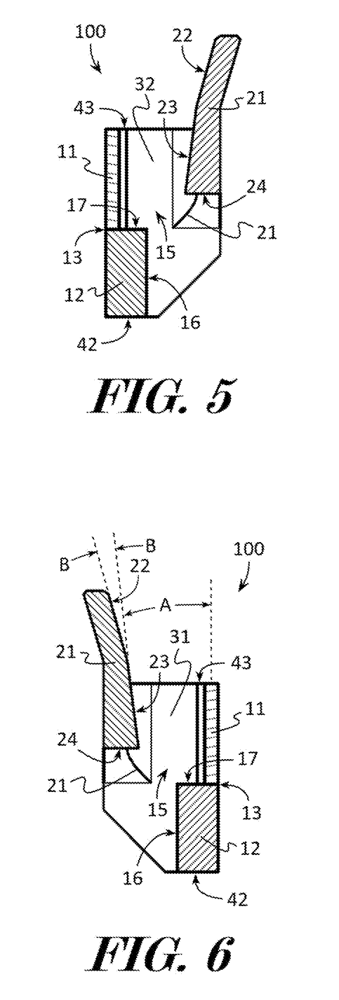

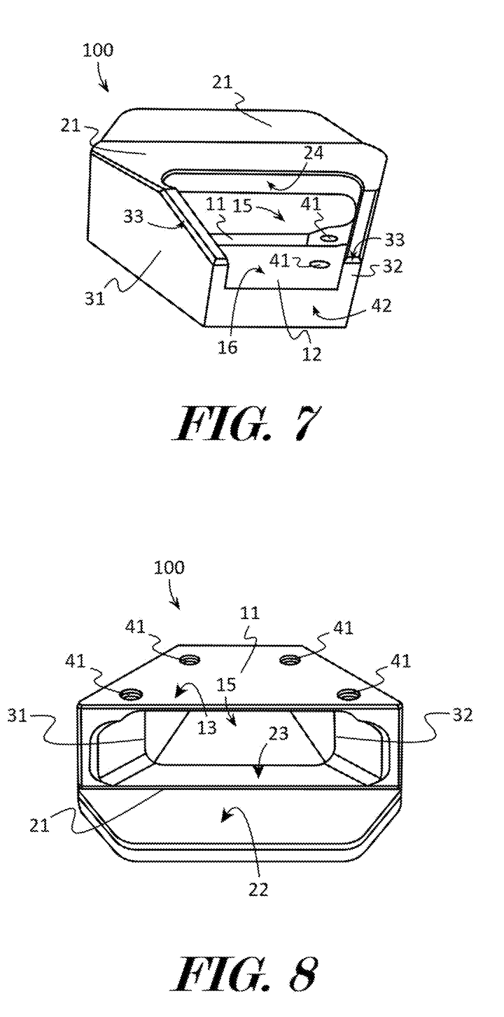

The present invention will now be described by example and through referencing the appended figures representing preferred and alternative embodiments. FIGS. 1-8 and 10-12 illustrate examples of a theft prevention saddlebag receiver latch bracket (“the bracket”) 100 according to various embodiments. In some embodiments, the bracket 100 may comprise a base 11 and a guide ramp 21. A first sidewall 31 and a second sidewall 32 may opposingly couple the base 11 and guide ramp 21 together to form a lid latch hook cavity 15. The guide ramp 21 may preferably comprise a latch guide surface 22, a latch ramp surface 23, and a retaining surface 24. The base 11 may further include a latch stop 12, a mounting surface 13, and one or more mounting apertures 41. The latch stop 12 may be disposed on the opposite side of the base 11 to which the mounting surface 13 is disposed. A lid latch hook 200 may be directed by the guide ramp 21 and sidewall 31, 32, into the lid latch hook cavity 15. The retaining surface 24 may engage with the lid latch hook 200 to retain the lid latch hook 200 in the lid latch hook cavity 15 to limit vertical movement of the lid latch hook 200. Outward movement of the lid latch hook 200, away from the base 11, may be limited by the latch ramp surface 23, while inward movement of the lid latch hook 200, towards the base 11, may be limited by the latch stop 12.

In preferred embodiments, the bracket 100 may be made from or comprise a high strength material such as, but not limited to, aircraft grade high tensile strength aluminum with a hard anodized finish. Optionally, the bracket 100 may be made from a single piece of material with the elements of the bracket machined into shape. In further embodiments, the bracket 100 may be made from or comprise steel alloys, other aluminum alloys, any other type of metal or metal alloy, any type of ceramic, various types of hard plastics, such as nylon, acrylic, uPVC, HDPE, melamine, hard rubbers, fiberglass, carbon fiber, resins, such as epoxy resin, or any other material including combinations of materials that are substantially rigid.

The bracket 100 includes a base 11 which may be coupled to a saddlebag such as Harley Davidson FL series touring style hard saddlebags. In preferred embodiments, the base 11 may comprise a generally flat or planar mounting surface 13 which may contact portions of a saddlebag to which the bracket 100 may be coupled to. In other embodiments, the base 11 may comprise a generally convex curved, concave curved, angled, or any other shaped mounting surface 13 which may contact portions of a saddlebag to which the bracket 100 may be coupled to. The bracket 100 may include one or more mounting surfaces 13 in any shape or size. In some embodiments and as shown in FIGS. 1, 2, 4, and 8, the base 11 may comprise a mounting surface 13 configured with a generally quadrilateral shape, such as a trapezoid. In alternative embodiments, the base 11 may comprise one or more mounting surfaces 13 in which each mounting surface 13 is configured in any shape or size.

In further embodiments, the bracket 100 may comprise one or more mounting apertures 41 which may extend through the base 11 and which may be configured to receive a fastener which may be used to couple the bracket 100 to a saddlebag. In preferred embodiments, the bracket 100 may comprise four mounting apertures 41 which may be positioned and oriented in the same manner as fastener apertures that are standard on a Harley Davidson FL series touring style hard saddlebag, generally in a trapezoidal shape or orientation to each other, so that the bracket 100 may be coupled to the saddlebag using existing hardware and fastener apertures of the saddlebag. Preferably, mounting apertures 41 may be threaded, although a mounting aperture 41 may comprise any shape and size which may enable any type of fastener to couple the base 11 to a saddlebag via the mounting aperture 41.

The base 11 may comprise one or more latch stops 12 which may be positioned on the bottom of the bracket 100 and preferably coupled to lower portions of the base 11, optionally to the first sidewall 31, and optionally to the second sidewall 32. A latch stop 12 may include a latch stop vertical surface 16 and a latch stop horizontal surface 17. A latch stop 12 may be disposed on the opposite side of the base 11 to which the mounting surface 13 is disposed. A latch stop vertical surface 16 may limit inward movement of a lid latch hook 200 towards the base 11 that is received by the bracket 100. Preferably, a latch stop vertical surface 16 may be approximately perpendicular to a latch stop horizontal surface 17. In some embodiments, a retaining surface 24 of a guide ramp 21 may be generally parallel (plus or minus 10 degrees) to a latch stop horizontal surface 17, and preferably angled approximately 5 degrees to a latch stop horizontal surface 17 so that portions of the retaining surface 24 that are relatively closer to the latch stop horizontal surface 17 may be relatively closer to an upper surface 43 than portions of the retaining surface 24 that are relatively farther from the latch stop horizontal surface 17. In further embodiments, a latch stop vertical surface 16 may be generally parallel (plus or minus 10 degrees) to a mounting surface 13 of the base 11, and preferably angled approximately 5 degrees to a mounting surface 13 of the base 11 so that portions of the latch stop vertical surface 16 that are relatively closer to a lower surface 42 may be relatively farther from a mounting surface 13 than portions of the latch stop vertical surface 16 that are relatively farther from the lower surface 42.

The base 11 may be coupled to the guide ramp 21 with a first sidewall 31 and a second sidewall 32. Preferably, a sidewall 31, 32, may extend from the top of the base 11 to the bottom of the base 11 and optionally be coupled to the latch stop 12. In some embodiments, the sidewalls 31, 32, may be angled relative to each other, so that upper portions of the sidewalls 31, 32, are relatively farther apart, while lower portions of the sidewalls 31, 32, that are closer to the latch stop 12 may be relatively closer together. In this manner, the first sidewall 31 and second sidewall 32 may be angled away from each other to form a generally trapezoidal prism shaped lid latch hook cavity 15. Optionally, a sidewall 31, 32, or any other element described herein may comprise one or more beveled surfaces 33.

In some embodiments, the bracket 100 may comprise a lower surface 42 which may be formed by or coupled to portions of one or more sidewalls 31, 32, and/or portions of a latch stop 12. In further embodiments, the bracket 100 may comprise one or more upper surfaces 43, such as a first upper surface 43A (FIG. 12) and a second upper surface 43B (FIG. 12), which may be formed by or coupled to portions of one or more sidewalls 31, 32, and/or upper portions of the base 11. Preferably, a lower surface 42 may be generally parallel (plus or minus 15 degrees) to one or more upper surfaces 43, 43A, 43B.

The guide ramp 21 may be coupled to the first sidewall 31 and second sidewall 32 and positioned so that the guide ramp 21 opposes the base 11. The first sidewall 31 and second sidewall 32 may be opposingly positioned to each other while being coupled to the base 11 and to the guide ramp 21. In some embodiments, the guide ramp 21 may include a latch guide surface 22, a latch ramp surface 23, and/or a retaining surface 24.

A latch ramp surface 23 may form a surface of the guide ramp 21 which may contact generally vertical portions of a lid latch hook 200 that is engaged to the bracket 100 within the lid latch hook cavity 15. In some embodiments, a latch ramp surface 23 may be generally parallel (plus or minus 15 degrees) to portions of the base 11, such as the mounting surface 13 and/or latch stop vertical surface 16. In further embodiments, the latch ramp surface 23 may be angled away from the base 11 as shown by Angle A in FIG. 6. In still further embodiments, the latch ramp surface 23 may be angled away from the base 11 by being angled away from portions of the base 11, such as the mounting surface 13 and/or latch stop vertical surface 16 as shown by Angle A in FIG. 6. In some embodiments, Angle A may be approximately between 0.01 degrees and 20 degrees, and preferably Angle A may be approximately 10 degrees.

A latch guide surface 22 may form a surface of the guide ramp 21 which may contact to direct or guide portions of a lid latch hook 200 into the lid latch hook cavity 15. Optionally, a latch guide surface 22 and a latch ramp surface 23 may be generally parallel so as to be generally continuous so that Angle A may describe the angle between all or portions of the base 11 and both the latch guide surface 22 and latch ramp surface 23. Preferably, a latch guide surface 22 may be angled away from the latch ramp surface 23 as shown by Angle B in FIG. 6. In this manner, the sum of Angle A and Angle B may describe the angle between all or portions of the base 11 and the latch guide surface 22. Preferably, Angle B may be approximately between 0.01 degrees and 15 degrees.

Generally, a retaining surface 24 may be generally perpendicular to portions of the base 11, such as the mounting surface 13 and/or latch stop vertical surface 16, or otherwise oriented so that portions of a lid latch hook 200 may engage with the retaining surface 24 to secure or retain the lid latch hook 200 within the bracket 100. In preferred embodiments, a latch guide surface 22, a latch ramp surface 23, and a retaining surface 24 may be continuous with each other or otherwise oriented so that portions of a lid latch hook 200 may slide or be guided into the lid latch hook cavity 15 as portions of the lid latch hook 200 move across the latch guide surface 22 and latch ramp surface 23 and into contact with the retaining surface 24. In other embodiments, a guide ramp 21 may comprise a latch guide surface 22 or a latch ramp surface 23 which may be shaped to guide portions of a lid latch hook 200 into contact with a retaining surface 24.

It should be understood to one of ordinary skill in the art that the elements of the bracket 100 may be configured in a plurality of sizes and shapes including square shaped, rectangular shaped, cylinder shaped, cuboid shaped, hexagonal prism shaped, triangular prism shaped, or any other geometric or non-geometric shape, including combinations of shapes. In preferred embodiments, all or portions of the latch stop horizontal surface 17 may be positioned approximately between 0.5 and 0.20 inches, and more preferably between 0.30 and 0.25 inches, below or lower than all or portions of the retaining surface 24. In further preferred embodiments, all or portions of the latch stop vertical surface 16 may be positioned approximately between 0.50 and 0.25 inches, and more preferably between 0.40 and 0.30 inches, away from all or portions of the latch ramp surface 23. However, it is not intended herein to mention all the possible shapes, sizes, alternatives, equivalent forms or ramifications of the invention. It is understood that the terms and proposed shapes used herein are merely descriptive, rather than limiting, and that various changes, such as to size and shape, may be made without departing from the spirit or scope of the invention.

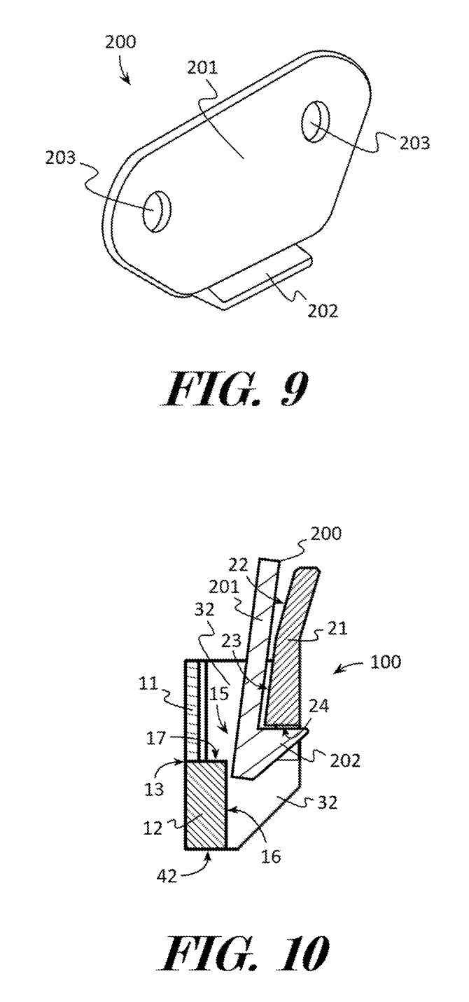

As perhaps best shown in FIGS. 9 and 10, the bracket 100 may comprise a lid latch hook cavity 15 which may be shaped to receive portions of a lid latch hook 200. A lid latch hook 200 is commonly employed on saddlebags, such as a Harley Davidson FL series touring style hard saddlebags, and used to removably couple the lid of a saddlebag to the body or container portion of the saddlebag. Generally, a lid latch hook 200 may comprise a planar body 201 optionally having a generally trapezoidal shape which may be relatively wider at the top and relatively narrower at the bottom. A retaining hook 202 may be coupled to or proximate to the bottom of the body 11. The body 11 may further comprise one or more fastener apertures 203 which may be used to couple the body 11 to a saddlebag via one or more fasteners.

In preferred embodiments, the lid latch hook cavity 15 may be shaped or configured to funnel or otherwise direct the movement of the retaining hook 202 of a lid latch hook 200 into contact with the retaining surface 24. Once a lid latch hook 200 is received in the lid latch hook cavity 15 of the device 100, the retaining surface 24 may engage with the retaining hook 202 of the lid latch hook 200 to retain the lid latch hook 200 in the lid latch hook cavity 15 to limit vertical movement of the lid latch hook 200 and prevent the lid latch hook 200 from being vertically forced or pulled out of the lid latch hook cavity 15 without first opening up the saddlebag. Outward movement of the retaining hook 202 of the lid latch hook 200, away from the base 11, may be limited by contact between the body 201 and the latch ramp surface 23, while inward movement of the retaining hook 202 of the lid latch hook 200, towards the base 11, may be limited by contact between the body 201 and the latch stop 12. By limiting the outward and inward movement of the lid latch hook 200 in the lid latch hook cavity 15, the retaining hook 202 of the lid latch hook 200 may be prevented from being pried or otherwise forced out of the lid latch hook cavity 15.

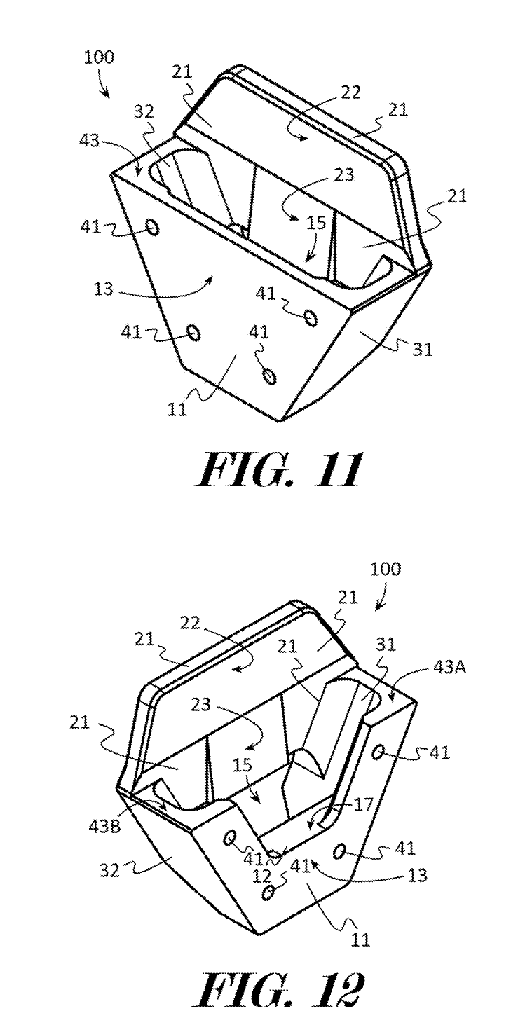

FIGS. 11 and 12 illustrate alternative examples of a bracket 100 according to various embodiments described herein. In some embodiments and as shown in FIGS. 11 and 12, the guide ramp 21 may comprise a latch ramp surface 23 which may only extend across a portion of width of the guide ramp 21. Preferably, a latch ramp surface 23 which may only extend across a portion of width of the guide ramp 21 may be positioned generally centrally on the guide ramp 21 so that the retaining hook 202 of a lid latch hook 200 may contact and slide over the generally centrally positioned latch ramp surface 23 as the lid latch hook 200 is moved into and/or out of the lid latch hook cavity 15. In some embodiments and as shown in FIG. 12, the base 11 may comprise a mounting surface 13 configured with a generally eight-sided polygon shape, such as a “U” shape.

While some materials have been provided, in other embodiments, the elements that comprise the bracket 100 such as the base 11, latch stop 12, guide ramp 21, first sidewall 31, second sidewall 32, and/or any other element discussed herein may be made from or comprise durable materials such as aluminum, steel, other metals and metal alloys, wood, hard rubbers, hard plastics, fiber reinforced plastics, carbon fiber, fiber glass, resins, polymers or any other suitable materials including combinations of materials. Additionally, one or more elements may be made from or comprise durable and slightly flexible materials such as soft plastics, silicone, soft rubbers, or any other suitable materials including combinations of materials. In some embodiments, one or more of the elements that comprise the bracket 100 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the bracket 100 may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, slide-to-lock type connection method or any other suitable temporary connection method as one reasonably skilled in the art could envision to serve the same function. In further embodiments, one or more of the elements that comprise the bracket 100 may be coupled by being one of connected to and integrally formed with another element of the bracket 100.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A theft prevention saddlebag receiver latch bracket, the bracket comprising:
a base comprising a latch stop;
a mounting surface disposed on the base opposite to the latch stop;
a first sidewall and a second sidewall opposingly positioned to each other, wherein the first sidewall is coupled to the base, and wherein the second sidewall is coupled to the base;
a guide ramp opposingly positioned to the base, the guide ramp coupled to the first sidewall and to the second sidewall, wherein the guide ramp comprises a latch ramp surface and a retaining surface; and
a lid latch hook cavity formed between the base, latch stop, first sidewall, second sidewall, and guide ramp.

2. The bracket of claim 1, wherein the latch stop comprises a latch stop horizontal surface, and wherein the latch stop horizontal surface is positioned approximately between 0.50 and 0.20 inches below the retaining surface.

3. The bracket of claim 1, wherein the latch stop comprises a latch stop horizontal surface, and wherein the latch stop horizontal surface is positioned approximately between 0.30 and 0.25 inches below the retaining surface.

4. The bracket of claim 1, wherein the latch stop comprises a latch stop horizontal surface, and wherein the latch stop horizontal surface is generally parallel to the retaining surface.

5. The bracket of claim 1, wherein the latch stop comprises a latch stop vertical surface, and wherein the latch stop vertical surface is positioned approximately between 0.50 and 0.25 inches away from the latch ramp surface.

6. The bracket of claim 1, wherein the latch stop comprises a latch stop vertical surface, and wherein the latch stop vertical surface is positioned approximately between 0.40 and 0.30 inches away from the latch ramp surface.

7. The bracket of claim 1, wherein the first sidewall and second sidewall are angled away from each other to form a generally trapezoidal prism shaped a lid latch hook cavity.

8. The bracket of claim 1, further comprising a mounting aperture.

9. The bracket of claim 1, wherein the mounting surface is generally planar.

10. The bracket of claim 1, wherein the latch ramp surface is angled away from the base.

11. The bracket of claim 1, wherein the guide ramp further comprises a latch guide surface, and wherein the latch guide surface is angled away from the latch ramp surface.

12. The bracket of claim 1, wherein the latch stop comprises a latch stop vertical surface, and wherein the latch stop vertical surface is generally parallel to the mounting surface.

13. A theft prevention saddlebag receiver latch bracket, the bracket comprising:
a base comprising a latch stop, wherein the latch stop comprises a latch stop horizontal surface and a latch stop vertical surface;
a mounting surface disposed on the base opposite to the latch stop;
a first sidewall and a second sidewall opposingly positioned to each other, wherein the first sidewall is coupled to the base, and wherein the second sidewall is coupled to the base;
a guide ramp opposingly positioned to the base, the guide ramp coupled to the first sidewall and to the second sidewall, wherein the guide ramp comprises a latch ramp surface and a retaining surface, wherein the latch stop horizontal surface is positioned approximately between 0.5 and 0.20 inches below the retaining surface, and wherein the latch stop vertical surface is positioned approximately between 0.50 and 0.25 inches away from the latch ramp surface; and
a lid latch hook cavity formed between the base, latch stop, first sidewall, second sidewall, and guide ramp, wherein the sidewalls are angled to form a generally trapezoidal prism shaped a lid latch hook cavity.

14. The bracket of claim 13, wherein the latch stop horizontal surface is positioned approximately between 0.30 and 0.25 inches below the retaining surface.

15. The bracket of claim 13, wherein the latch stop horizontal surface is generally parallel to the retaining surface.

16. The bracket of claim 13, wherein the latch stop vertical surface is positioned approximately between 0.40 and 0.30 inches away from the latch ramp surface.

17. The bracket of claim 13, wherein the mounting surface is generally planar.

18. The bracket of claim 13, wherein the latch ramp surface is angled away from the base.

19. The bracket of claim 13, wherein the guide ramp further comprises a latch guide surface, and wherein the latch guide surface is angled away from the latch ramp surface.

20. The bracket of claim 13, wherein the latch stop comprises a latch stop vertical surface, and wherein the latch stop vertical surface is generally parallel to the mounting surface.
